(19) United States
(12) Patent Application Publication
(10) Pub. No.: US 2011/0101128 A1
(43) Pub. Date: May 5, 2011

(54) Mist Fan

(76) Inventor: Ping Huang, Yung Kang (TW)

(21) Appl. No.: 12/588,894

(22) Filed: Nov. 2, 2009

(51) Int. Cl. B05B 15/00

(52) U.S. Cl. 239/289

(57) ABSTRACT

A mist fan comprises a fan and a mister disposed in the interior of a housing. The mister has a mist discharge orifice provided on one side to communicate with a mist puff opening formed on the housing. The other side of the mister is connected to a liquid introducing tank that is placed within a liquid bucket chamber of the housing. The bucket chamber can accommodate a liquid bucket, and the liquid contained in the liquid bucket can flow into the mister through the liquid introducing tank. The liquid in the liquid bucket is atomized by the mister and the mist is puffed to the outside from the mist discharge orifice through the mist puff opening on the housing. Then, the mist is uniformly distributed to the ambience by the wind produced from the fan. Thus, better indoor humidity conditioning can be attained by the mist fan.

### BACKGROUND OF THE INVENTION

1. Field of the Invention

The present invention relates to a mist fan, particularly to a mist fan capable of providing uniformly distributed mist to the ambience for indoor humidity regulation.

2. Brief Description of the Prior Art

Due to high density of housing and popularity of air conditioning and heating device, indoor air is often in low-humidity and dry condition. In order to avoid negative effect on human body's health caused by excessively dry air, the industries have developed humidifier that is able to raise indoor humidity by atomizing prestored liquid into mist that is then distributed everywhere in the interior to raise the indoor humidity.

The humidifier frequently seen on the market usually comprises a liquid bucket. The liquid contained in the liquid bucket flows into a mister through the control of a valve, and is treated by oscillation in the mister to produce mist. Then, the mist is puffed to the outside from the outlet and is dispersed in the ambience so as to raise the ambient humidity.

Although the above humidifier can reach expected effectiveness of, producing mist and providing appropriate humidity to ambience, however it is found in practical application that the mist produced by the mister is unable to be diffused to farther place in the interior by means of mist pressure only. The mist discharged from the mister is inclined to gather around the humidifier so that the humidity in proximity to the humidifier is increased quickly. However, the humidity in farther place remains unchanged. Thus, there are still spaces for improvement in its total implementation and usage.

In view of the above facts, inventor of the present invention provides a new mist fan according to the improvement conducted on defects of the existing structure based on his abundant experience of R&D and manufacturing in relevant field so as to attain better performance in practical application.

### SUMMARY OF THE INVENTION

The mist fan of the present invention essentially comprises a fan and a mister in the interior of its housing. A guard grille opposite to the hood of the fan is provided on the outside of the housing. A mist discharge orifice is provided on one side of the mister, and a liquid introducing tank having a bulge portion is connected to the other side of the mister. A mist puff opening opposite to the bottom edge of the guard grille is provided on the housing. The mist puff opening is in communication with a mist discharge orifice of the mister. Further, a liquid bucket chamber is formed on one side of the housing. The liquid introducing tank of the mister is provided in the liquid bucket chamber, and the liquid bucket chamber can accommodate a liquid bucket. The liquid bucket has a bucket opening on its one end and a cap is provided to cover the bucket opening. An outlet bore is penetrated through the cap. A fixed stopper is provided in the outlet bore, and a linking rod passing through the fixed stopper is used to abut against the bulge portion in the liquid introducing tank. A valve member abutted against the inside of the bucket opening is connected to the inner end of the linking rod. A restoring elastic element is placed between the fixed stopper and the linking rod. In this way, the liquid in the bucket is atomized by the mister and the mist is puffed to the outside from the mist discharge orifice, which is provided at a place opposite to the bottom edge of the guard grille, through the mist puff opening on the housing. Then, the mist is uniformly distributed to the ambience by the wind blowing through the guard grille from the fan. Thus, mist can provide required humidity appropriate to the indoor environment, and the mist can be uniformly distributed throughout the ambience so as to avoid negative effect on human body's health caused by excessively dry air. It can increase more practical value in the integral embodiment and usage thereof.

### BRIEF DESCRIPTION OF THE DRAWINGS

FIG. 1 is a perspective exploded view showing the structure of the mist fan of the present invention.

FIG. 2 is a perspective assembled view showing the structure of the mist fan of the present invention.

FIG. 3 is a sectional assembled view showing the structure of the mist fan of the present invention.

FIG. 4 is a partial enlarged sectional assembled view showing the structure of the mist fan of the present invention.

FIG. 5 is a partial enlarged sectional view showing the structure of the mist fan of the present invention in use state.

FIG. 6 is a sectional view showing the structure of the mist fan of the present invention in use state.

### DETAILED DESCRIPTION OF PREFERRED EMBODIMENT

The objects, the technical contents and the expected effectiveness of the present invention will become more apparent from the detailed description of the preferred embodiment in conjunction with the accompanying drawings.

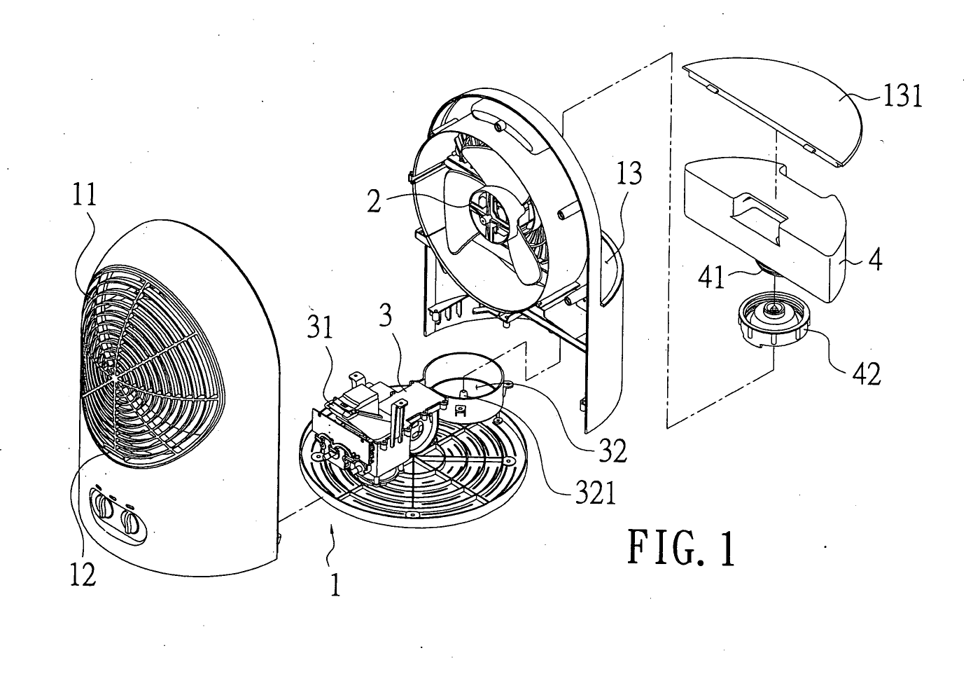

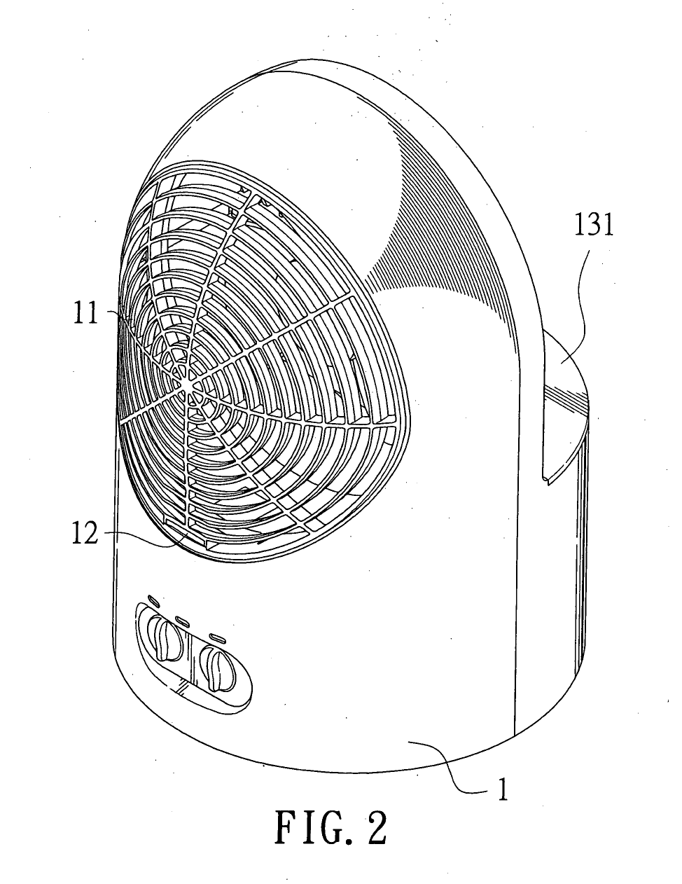

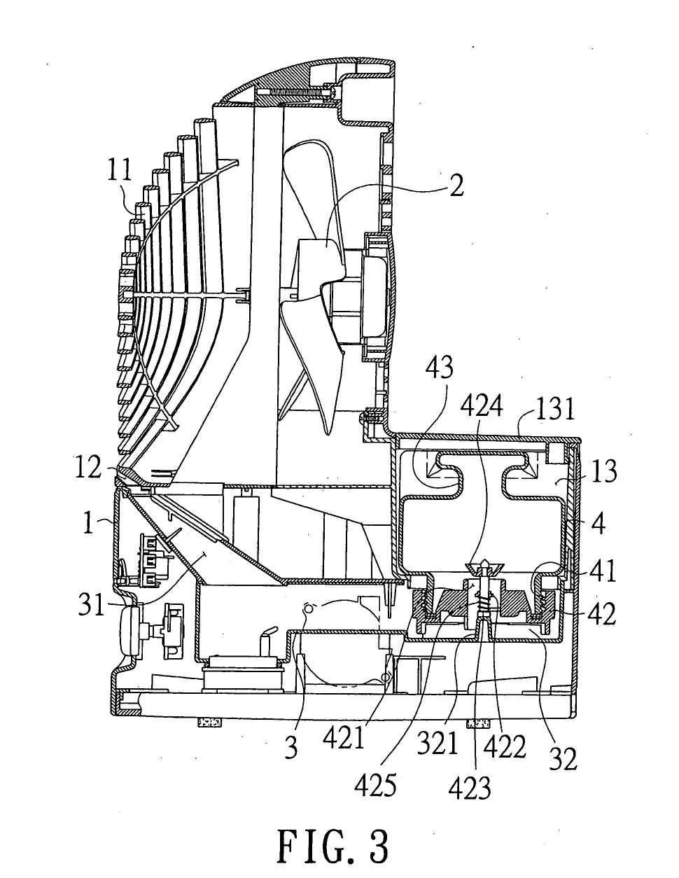

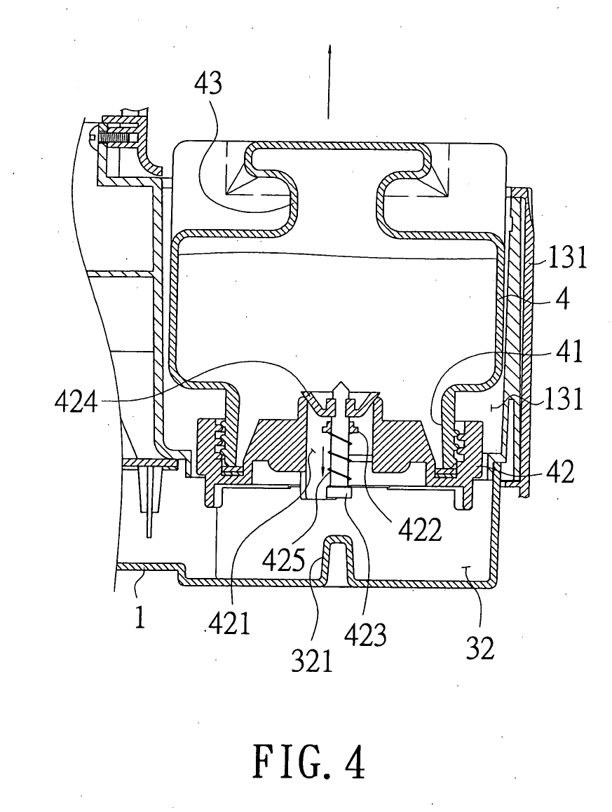

FIG. 1 is a perspective exploded view showing the mist fan of the present invention. As shown in FIG. 1, the mist fan of the present invention essentially comprises a housing (1), a fan (2), a mister (3) and a liquid bucket (4). Referring to FIGS. 2 and 3, the fan (2) is provided in the interior of the housing (1). A guard grille (11) opposite to the hood of the fan (2) is provided on the outside of the housing (1). Further, a mist (3) is also provided in the interior of the housing (1). A mist discharge orifice (31) is provided on one side of the mister (3), and a liquid introducing tank (32) having a bulge portion (321) is connected to the other side of the mister (3). A mist puff opening (12) opposite to the bottom edge of the guard grille (11) is provided on the housing (1). The mist puff opening (12) is in communication with the mist discharge orifice (31) of the mister (3). Further, a liquid bucket chamber (13) is formed on one side of the housing (1). The liquid introducing tank (32) of the mister (3) is provided in the liquid bucket chamber (13), and the liquid bucket chamber (13) can accommodate a liquid bucket (4). Referring to FIG. 4, the liquid bucket (4) has a bucket opening (41) provided on its one end and a cap (42) is provided to cover the bucket opening (41). An outlet bore (421) is penetrated through the cap (42). A fixed stopper (422) is provided in the outlet bore (421), and a linking rod (423) passing through the fixed stopper (422). A valve member (424) abutted against the inside of the bucket opening (41) is fixed to the inner end of the linking rod (423). A restoring elastic element (425) is placed between the fixed stopper (422) and the linking rod (423). In normal state, the linking rod (423) draws the valve member (424) outwardly to press against the inside of the bucket opening (41) by the expansion of the restoring elastic element (425), so that the liquid contained in the liquid bucket (4) will not flow out. A handheld portion (43) is formed at the other end of the liquid bucket (4). Further, a cover (131) is provided to cover the liquid bucket chamber (13) of the housing (1).

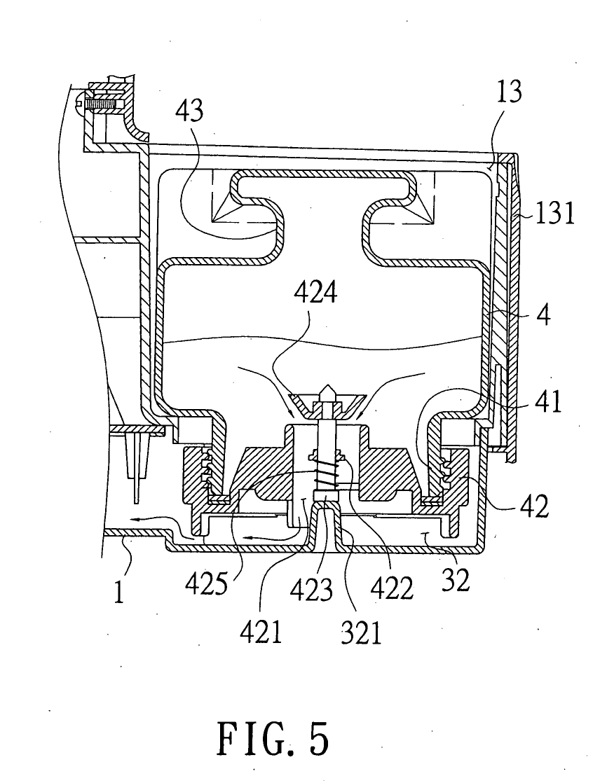

After the liquid bucket (4) is filled with liquid and the cap (42) is covered on the bucket opening (41), the liquid bucket (4) is disposed into the liquid bucket chamber (13) with the cap (42) facing downward. At this moment, the cap (42) of the liquid bucket (4) abuts against the bulge portion (321) of the liquid introducing tank (32) of the mister (3) such that the linking rod (423) penetrating through the fixed stopper (422) provided on the cap (42) is pushed inwardly. In turn, the valve member (424) is moved inwardly toward the inside together with the linking rod (423) so that the valve member (424) moves away from the abutment position with the bucket opening (41). Therefore, the liquid contained in the liquid bucket (4) can flow from the liquid introducing tank (32) through the outlet bore (421) into the mister (3), as shown in FIG. 5.

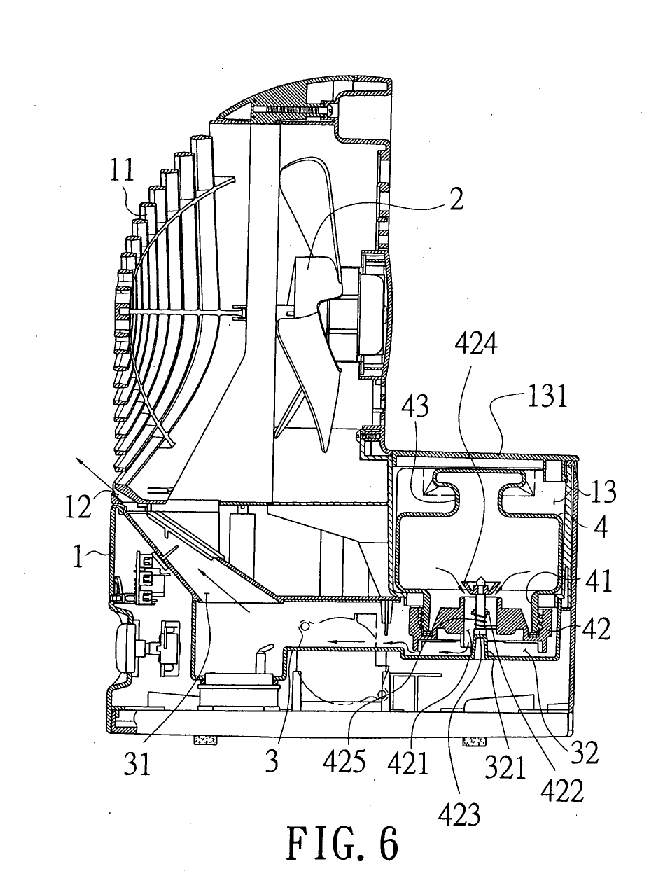

In this way, as shown in FIG. 6, the liquid flowed into the mister (3) is formed into mist by the oscillation action of the mister (3), and the mist thus formed is puffed to the outside from the mist puff opening (12), which is opposite to the bottom edge of the guard grille (11), provided on the housing (1) through the mist discharge orifice (31). Then, the mist is uniformly distributed to the ambience through the guard grille (11) by the wind produced from the fan (2) in the housing (1).

The abovementioned embodiment and drawings are not intended to restrict the structure or the dimensions of the present invention. Appropriate variations and modifications made by the person having ordinary knowledge in the art without departing from the spirit and scope of the present invention are still regarded to be within the scope of the present invention.

Based on the foregoing, the mist fan of the present invention has the following advantages, when comparing with prior art.

The mist fan of the present invention comprises a fan and a mister disposed in the interior of a housing. The mister has a mist discharge orifice provided on one side to communicate with a mist puff opening formed on the housing. The other side of the mister is connected to a liquid introducing tank that is placed in a liquid bucket chamber of the housing. The liquid bucket chamber can accommodate a liquid bucket, and the liquid contained in the liquid bucket can flows into the mister through the liquid introducing tank. The liquid in the liquid bucket is atomized into mist by the oscillation action of the mister and the mist thus formed is puffed to the outside from the mist discharge orifice through the mist puff opening on the housing. Then, the mist is uniformly distributed to the ambience by the wind produced from the fan. Thus, mist can provide required humidity appropriate to the indoor environment, and the mist can be uniformly distributed throughout the ambience so as to avoid negative effect on human body's health caused by excessively dry air.

Summing up above, the embodiment of the present invention is surely able to reach expected effectiveness in application, and the specific structure disclosed herein is not only unprecedented in the same category of product but also not open to the public before application.

What is claimed is:

1. A mist fan, comprising a housing, a fan, a mister and a liquid bucket, wherein:
the fan is disposed in the interior of the housing, a guard grille opposite to the hood of the fan being provided on the outside of the housing; a mist discharge orifice being formed on one side of the mister and a liquid introducing tank having a bulge portion being connected to the other side of the mister; a mist puff opening opposite to the bottom edge of the guard grille being provided on the housing, the mist puff opening being in communication with a mist discharge orifice of the mister; a liquid bucket chamber being formed on one side of the housing, the liquid introducing tank of the mister being disposed inside the liquid bucket chamber, and the liquid bucket chamber accommodating a liquid bucket, the liquid bucket having a bucket opening provided on its one end and a cap being provided to cover the bucket opening; an outlet bore penetrating through the cap, a fixed stopper being provided in the outlet bore and a linking rod passing through the fixed stopper being used to push against the bulge portion in the liquid introducing tank, a valve member abutted against the inside of the opening being connected to the inner end of the linking rod, a restoring elastic element being placed between the fixed stopper and the linking rod.

2. A mist fan as claimed in claim 1, wherein said liquid bucket is formed with a handheld portion on the other end.

3. A mist fan as claimed in claim 1, wherein a cover is provided to cover the liquid bucket chamber of the housing.
